(19) United States
(12) Patent Application Publication
(10) Pub. No.: US 2025/0023976 A1
(43) Pub. Date: Jan. 16, 2025

(54) INTEGRATED VEHICLE SOFTWARE AND REMOTE APPLICATION THEREFORE

(71) Applicant: Dr. Ing. h.c. F. Porsche Aktiengesellschaft, Stuttgart (DE)

(72) Inventors: Cyril Dorsaz, San Francisco, CA (US); Ethan Papp, Union City, CA (US); Chris Herbert, Los Angeles, CA (US); Thorsten Hayer, Pacifica, CA (US); Steffen Haug, Monte Sereno, CA (US); Thomas Bock, Belmont, CA (US)

(73) Assignee: Dr. Ing. h.c. F. Porsche Aktiengesellschaft, Stuttgart (DE)

(21) Appl. No.: 18/219,933

(22) Filed: Jul. 10, 2023

(51) Int. Cl. H04M 1/72409; B60H 1/00; H04W 4/48

(52) U.S. Cl. CPC H04M 1/724098; B60H 1/00657; B60H 1/00985; H04W 4/48

(57) ABSTRACT

A computer-implemented method and computer program product for presenting information about a vehicle function to a user of a vehicle and enabling control of the vehicle function. The method includes the steps of: (a) securely connecting a software application to a vehicle network; (b) selecting a vehicle function from a plurality of vehicle functions; (c) presenting to the user the information about the selected vehicle function; and (d) controlling the selected vehicle function based on preferences of the user. The computer program is configured to perform the aforementioned steps.

### TECHNICAL FIELD

The present subject matter relates to a system and method for presenting information about a vehicle function to a user of a vehicle and enabling control by the user of a selected in-vehicle function.

### BACKGROUND

The modern automobile in recent years has seen a massive expansion in the number of internal electronic control and driving assistance systems. The use of mobile and wearable electronic devices also continues to increase. Some automobiles either are or will soon be capable of communicating with a smartphone carried by, or a smartwatch worn by, a driver or a passenger in the vehicle. For example, a smartphone or an Apple Watch is (or soon will) be configured to communicate with an Apple CarPlay software system within the vehicle. With the rapid development of mobile technologies, users have higher demands for the convenience of use of in-vehicle software applications (e.g., “apps”). Currently, users can either use an original in-vehicle application provided by the vehicle manufacturer or connect a smartphone to the vehicle onboard computer, and then project an app installed on the smartphone onto the vehicle display screen through Apple CarPlay, Android Auto, CarLife, or other software connectivity protocols. Existing vehicle electronic control and driving assistance systems, however, do not offer much flexibility in terms of display and control of functions related to the operation of the vehicle. Advancements in the area of internal electronic control and driving assistance systems are continually sought in the interests of convenience, performance, and safety. There remains a need for new internal electronic control and driving assistance systems which can present information about in-vehicle functions to a user of a vehicle and allow the user to select and control a selected in-vehicle function, thereby enhancing the in-vehicle user experience, without much effort or distraction from driving.

### SUMMARY OF INVENTION

Described herein are a method and a computer program product for presenting information about a vehicle function to a user of a vehicle and enabling control of a selected vehicle function, thereby enhancing the in-vehicle experience. The method includes the steps of: (a) securely connecting a software application to a vehicle network; (b) selecting a vehicle function from a plurality of vehicle functions; (c) presenting to the user the information about the selected vehicle function; and (d) controlling the selected vehicle function based on preferences of the user. The computer program product is configured to perform the aforementioned steps.

### BRIEF DESCRIPTION OF THE DRAWINGS

The drawing figures depict one or more implementations, by way of example only, not by way of limitations. In the figures, like reference numerals refer to the same or similar elements.

FIG. 1 depicts a schematic diagram of a vehicle and (optional) mobile device connected to the vehicle.

FIG. 2 is a schematic diagram of a computer program according to an embodiment.

FIG. 3 is a flowchart depicting an overall method for presenting information about a vehicle function to a user of a vehicle and control of the selected in-vehicle function.

FIG. 4 is an exemplary user interface of a computer program according to an embodiment.

FIG. 5 is a flowchart depicting the method of FIG. 3 with additional details.

### DETAILED DESCRIPTION

In the following detailed description, numerous specific details are set forth by way of examples in order to provide a thorough understanding of the relevant teachings. However, it should be apparent to those skilled in the art that the present teachings may be practiced without such details. In other instances, well known methods, procedures, components, and/or circuitry have been described at a relatively high-level, without detail, in order to avoid unnecessarily obscuring aspects of the present teachings.

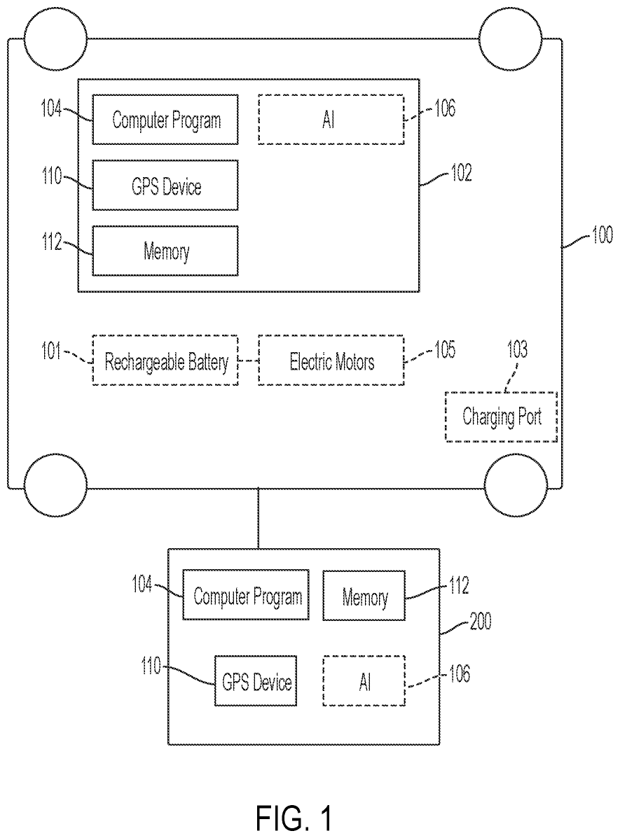

FIG. 1 depicts a vehicle 100. The vehicle 100 can be an electric vehicle having a rechargeable battery 101, a charging port 103 used for charging the battery 101, and one or more electric motors 105 receiving charge from battery 101 for driving wheels of vehicle 100. In certain embodiments, the vehicle 100 can be an autonomous driving vehicle or a semi-autonomous driving vehicle. Although FIG. 1 depicts vehicle 100 as an electric vehicle, in other embodiments, the vehicle 100 can be a standard driver-operated vehicle powered by a combustion engine that burns fuel, such as gasoline, diesel or ethanol, for example.

Regardless of the type of vehicle 100, vehicle 100 has a computer 102 for controlling functions related to the operations of vehicle 100. An electronic mobile device 200 (otherwise referred to herein as a smartphone) is connected to vehicle computer 102 via a wired or wireless connection (e.g., Wi-Fi, cellular or Bluetooth connection). It is noted that components that are shown in broken lines in FIG. 1 are optional.

Vehicle computer 102 includes a processor, a visual display having means for both inputting data and displaying data (e.g., touchscreen), and a transmitter/receiver for communicating with mobile device 200 in a conventional manner. For example, vehicle computer 102 may send and receive data via Wi-Fi or 4G/LTE radios built into vehicle 100, by way of example. Mobile device 200 includes a processor, a visual display having means for both inputting data and displaying data (e.g., touchscreen), and a transmitter/receiver for communicating with vehicle 100 in a conventional manner.

A computer program 104 or a software application (e.g., “app”) is downloaded to, installed on, and stored in, either computer 102 of vehicle 100 or electronic mobile device 200 (or both). According to one embodiment, program 104 is stored within the vehicle computer 102; information can be inputted into program 104 via the touchscreen display of vehicle computer 102; and information can be outputted from program 104 via the display of vehicle computer 102 (e.g., via Apple CarPlay or Android Auto). According to another embodiment, program 104 is stored within the mobile device 200; information can be inputted into program 104 via the display of mobile device 200; and information can be outputted from program 104 via the display of vehicle computer 102 (e.g., via Apple CarPlay or Android Auto). According to yet another embodiment, program 104 is a mobile application stored within the mobile device 200; information can be inputted into program 104 via the display of mobile device 200; and information can be outputted from program 104 via the display of mobile device 200. According to still another embodiment, program 104 is stored within the mobile device 200; information can be inputted into program 104 via the display of mobile device 200; and information can be outputted from program 104 via both the display of mobile device 200 and the display of vehicle computer 102.

In certain embodiments, users of the vehicle 100 may be identified by program 104 based on paired device data maintained in the memory 112 of program 104. The paired device data can indicate, for example, unique device identifiers of mobile devices that were previously paired with program 104 of the vehicle 100, such that program 104 may automatically reconnect previously connected mobile devices without user intervention.

Program 104 can be connected to receive and transmit information from/to a GPS device 110 (e.g., a GPS chip) that uses the Global Positioning System (GPS). GPS device 110 is configured to determine the location of vehicle 100 or mobile device 200 within vehicle 100 in a conventional manner. GPS device 110 may form part of vehicle computer 102 or mobile device 200, or both. This locational data can be stored in memory 112. Memory 112 may also form part of vehicle computer 102 or mobile device 200, or both.

In certain embodiments, program 104 can be configured to interact with an AI chatbot model, such as ChatGPT, for example, which can run as a third-party software application (e.g., “app”) AI 106 on vehicle computer 102 or on the mobile device 200 of the user of the vehicle 100. In other embodiments, the AI model can be a different AI-enabled software application 106 running on vehicle computer 102 or on the mobile device 200 of the user of the vehicle 100. Program 104 can be configured to interact with the AI model or ChatGPT app 106 and use ChatGPT's API to perform an action (e.g., query) specified by the user related to obtaining and presenting to the driver and/or the passengers in the vehicle an AI-generated information about an in-vehicle function, data related to the operation of the vehicle 100, or information about a location or a point of interest (POI) along the driving route of the vehicle 100. Further details of the AI model are described in U.S. patent application Ser. No. 18/201,799 filed on May 25, 2023, which is incorporated by reference herein in its entirety and for all purposes.

Program 104 can be designed and configured to connect directly to the network of the vehicle 100 and/or a third-party software applications (e.g., other “apps”) or devices via a direct connection application programming interface (API). For example, program 104 can be configured to interact with other apps installed on vehicle computer 102, such as different apps for social media, messaging, providing maps and navigation, playing music or podcasts, etc., that may be installed on, and be available via the display of, vehicle computer 102 (e.g., via Apple CarPlay or Android Auto), for example, or with other similar apps installed on mobile device 200. In these situations, because these apps are integrated with program 104, program 104 can use each specific app's API to perform an action specified by the user.

In certain embodiments, program 104 can appear as a selectable icon within Apple CarPlay. Program 104 can be configured to connect the network of the vehicle 100 with the Apple ecosystem (e.g., with the different Apple devices, such as iPhone, iPad, MacBook, Apple Watch, AirPods, Apple TV, Apple CarPlay, etc.) that may be connected and integrated with each other, and that may be accessible within the vehicle 100. Once connected to the Apple ecosystem, program 104 can run in the background of Apple CarPlay, for example.

The network of the vehicle 100 can include one or more of a vehicle controller area network (“CAN”) or an Ethernet network, for example. The network of the vehicle 100 can allow, after proper and successful authentication, program 104 to communicate with various systems or components of vehicle 100, such as a vehicle modem (if available), GPS device 110 and various electronic control units (“ECUs”) configured to interface with program 104. For example, the vehicle ECUs may include a vehicle interior control module configured to monitor and control power control functions, such as interior lighting, for example; a radio transceiver module configured to provide radio services and communicate with mobile devices inside vehicle 100; and a climate control module configured to provide control and monitoring of heating, cooling, and ventilation system components (e.g., compressor clutch and blower fan control, temperature sensor information, etc.).

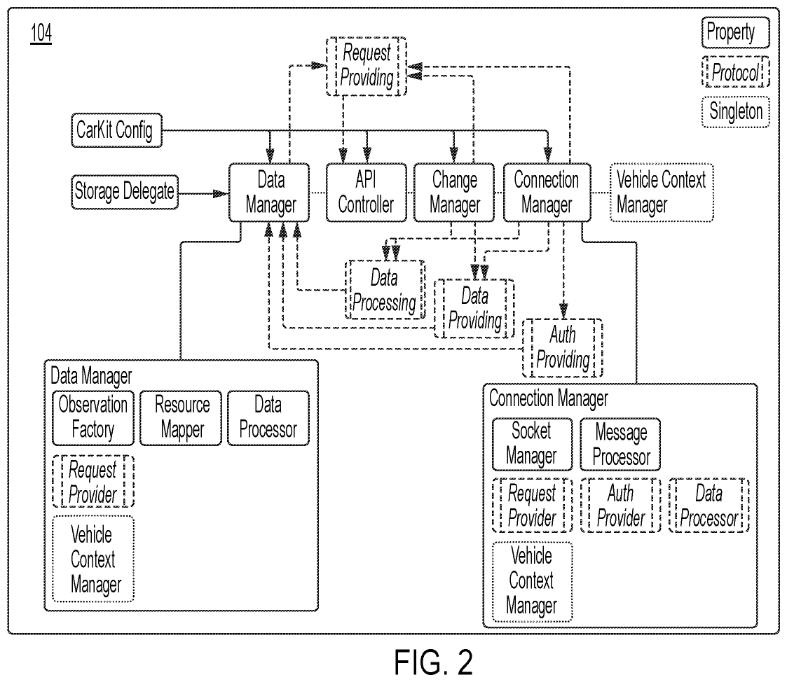

Program 104 can be configured to include different components to facilitate access to one or more features of vehicle 100 that may be provided with a default configuration by the manufactures of vehicle 100 and may be configured for changes or customization by the user of vehicle 100. For example, program 104 can include a Data Manager, a Connection Manager, an API Controller, and a Change Manager, as illustrated in FIG. 2, for example. The Data Manager can be configured, for example, to provide, process, and update an RSI Request-Response Interface authorization and RSI resource mapping. The Connection Manager can be configured, for example, to check network conditions through a network controller, re-check connection when network conditions change, search for an infotainment web interface protocol, such as the Volkswagen Infotainment Web Interface (“VIWI”) RSI service, for example, handle authentication, collect initial information (e.g., vehicle data) about different components of the vehicle 100, and process updates to vehicle data requested by the user of vehicle 100.

Program 104 can be configured to access a list of available features of the vehicle 100, including but not limited to initial or default values of the available features of the vehicle 100, before allowing the user of vehicle 100 access to modify or customize the available features of the vehicle 100. Once program 104 has gathered and parsed the initial vehicle data, program 104 can monitor for any changes to the initial vehicle data. For example, program 104 can open a WebSocket API as a two-way interactive communication session between the user's interface of program 104 and a server connected to a two-way interactive communication session between the user's browser and a server to observe, process, and store any and all changes by the user to the initial vehicle data. After the user's modifications to any of the available features of the vehicle 100 are processed and stored in the memory 112 of program 104, program 104 can be configured to synchronize the modified features of the vehicle 100 with the corresponding system or component of the vehicle 100.

In certain embodiments, program 104 can auto-subscribe or self-subscribe to receive a notification message for each user's modification to a feature of the vehicle 100, including but not limited to changes to elements included within a feature (e.g., in the case of a complex, compound feature related to more than one setting of a vehicle component or to multiple settings of multiple vehicle components), in addition to changes to the feature of the vehicle 100 itself. For example, when the user's modification relates to a feature affecting climate or ventilation control in the interior of the vehicle 100, program 104 can be configured to be notified when any of the fan settings or the temperature values has been changed by the user.

In addition, program 104 can be configured to auto detect any smart devices (e.g., smart phones, smart watches, tablets, etc.) that are compatible with program 104, and that may be accessible within the vehicle 100, and auto connect with these devices as soon as they are setup, without the necessity for the user to set up these devices each time. As another example, program 104 can connect to a smart device via a direct connection application programming interface (API).

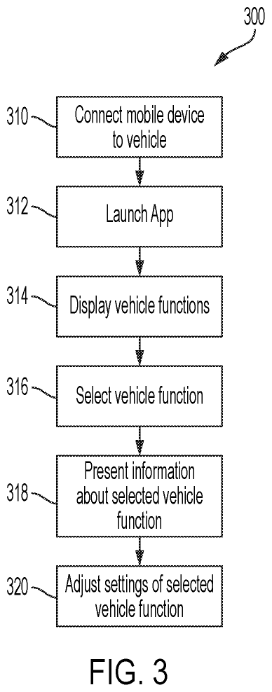

FIG. 3 is a flowchart depicting an overall method 300 for presenting information about a vehicle function 500 to a user of the vehicle 100. The user of the vehicle 100 can be a driver of the vehicle 100 or a passenger in the vehicle 100.

At the outset it is noted that method 300 uses mobile device 200 along with vehicle 100 to accomplish method 300, however, it should be understood that mobile device 200 may be omitted and the steps of method 300 may be completed using only vehicle computer 102 of vehicle 100.

At step 310 of method 300, mobile device 200 connects to vehicle 100 in either a wired or wireless manner, as described above. If the steps of method 300 are completed by vehicle 100 itself (and without the assistance of mobile device 200), then this step may be omitted.

Optionally, after the connection between the mobile device 200 and the vehicle 100 is established, program 104 can initiate an authentication of the mobile device 200 and/or the vehicle 100. The authentication can be performed using known methods, such as Transport Layer Security (“TLS”) 1.2 security protocol, public pinning hash, local certificate pinning, PIN numbers that can be entered by the user or QR codes that can be scanned by the mobile device 200, for example. Further functionality of program 104 can be disabled until after the mobile device 200 and/or the vehicle 100 successfully complete the authentication process (e.g., the mobile device 200 confirms that the saved user and vehicle information is stored in the vehicle 100).

At step 312, the user (e.g., driver or passenger of vehicle 100) launches program 104 on vehicle computer 102 or mobile device 200. Step 312 may occur either prior to a vehicle trip or during the vehicle trip.

At step 314, program 104 displays one or more vehicle functions 500 of the vehicle 100. The vehicle functions 500 can include, but are not limited to, radio favorites, a plurality of sound profiles, a plurality of climate control modes, and a plurality of wellness modes, for example.

The vehicle functions 500 may be saved in the memory 112 of the vehicle computer 102 or mobile device 200, for example.

Before displaying to the user the internal listing of vehicle functions 500 in step 314, the listing may be sorted, arranged and organized in a certain fashion.

As one example for sorting the listing, program 104 checks for the most recently used or the most often used vehicle function(s) 500 and automatically organizes the vehicle functions 500 such that the most recently used or the most often used vehicle function(s) 500 appear at the top of the list.

As another example, program 104 can recognize the user of the vehicle 100 (e.g., in case multiple users use the same vehicle 100) and can automatically display the vehicle functions 500 that were most recently used or are most often used by the recognized user.

At step 316, program 104 receives from the user (e.g., driver or passenger) of the vehicle 100 user input selecting a vehicle function 500 among the vehicle functions 500 that were displayed to the user at step 314. The user input can be in the form of the user selecting an icon or pressing a button on the touchscreen of vehicle computer 102 within the user interface of program 104. Alternatively, the user input can be in the form of a voice command by the user over an audio system of the vehicle 100. In certain embodiments, for example, Apple Siri can be expanded to enable user input, selection, and modification of vehicle features 500 through the program 104.

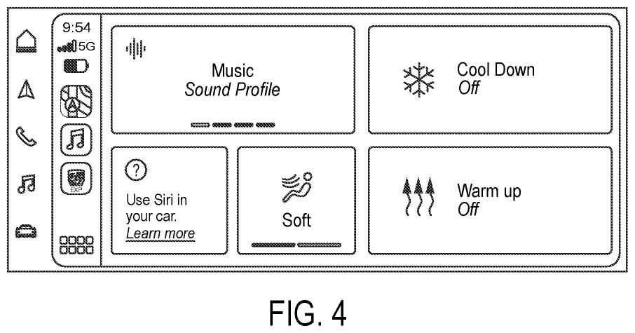

According to this embodiment, the user selection is accomplished using the input device (e.g., touch screen, stylus, mouse pad, keyboard, etc.) of vehicle 100, however, it should be understood that the selection could be accomplished using the input device (e.g., touch screen) of mobile device 200. The user's selection can be saved in memory 112 of vehicle computer 102 or mobile device 200 for either current use or later use. The user's selection saved in memory 112 is made available for use by program 104. Once saved, the saved vehicle functions 500 may be presented to the user as selectable icons (e.g., icons named “Radio,” “Music,” “Cool Down,” “WarmUp,” “Relax,” “Energize,” etc.), for example, on the display of vehicle computer 102 or mobile device 200. Each icon may be in the form of a single softkey button on the display and within the user interface of program 104, as partially illustrated in FIG. 4, for example.

In certain embodiments, program 104 can receive from the user (e.g., driver or passenger) of the vehicle 100 user input selecting a category or a type of the vehicle functions 500 that the user is interested in controlling or adjusting, such as radio favorites, sound profiles, climate control modes, wellness modes, etc., for example.

Program 104 can also receive from the user (e.g., driver or passenger) of the vehicle 100 additional user input further limiting the displayed the vehicle functions 500. For example, as part the user input, the user can add a randomness component into the user input, such as the purpose of the user input, e.g., “with the goal to”: “Cool Down,” “WarmUp,” “Relax,” “Energize,” etc.

Turning back to FIG. 3, at step 318, program 104 presents the information about the selected vehicle function 500 to the user of the vehicle 100 (e.g., driver, passengers). For example, the information about the selected vehicle function 500 can be presented to the user via the touchscreen display of vehicle computer 102 (e.g., via Apple CarPlay or Android Auto) of the vehicle 100. Alternatively, the information about the selected vehicle function 500 can be presented to the user via a Text-to-Speech (″TTS″) technology over the audio system of the vehicle 100.

Step 318 of presenting to the user the information about the selected vehicle function 500 can include, for example, vehicle features and ecosystem features grouped in three main categories: a default category of actions called essentials, for example, including daily or most used features, quick actions (allowing the user to select and configure quick actions from a predetermined list of features), and specialty actions, such as entertainment (for media), for example. For example, the daily features can include radio favorites, vehicle climate modes, vehicle air distribution, destinations, weather, air quality index (AQI), music, etc.

In certain embodiments, program 104 can aggregate vehicle data obtained from the vehicle network and the vehicle systems and offer to the user combinations for controlling or adjusting vehicle functions 500 that share a specific attribute by controlling a certain in-vehicle component (e.g., lighting, climate, ventilation, radio, sound system, etc.). As a specific example, the user may utilize program 104 running on vehicle computer 102 or on smartphone 200 to turn on all vehicle interior lights, but at a low intensity level.

In other embodiments, program 104 can aggregate vehicle data obtained from the vehicle network and the vehicle systems and offer to the user combinations for controlling or adjusting vehicle functions 500 that do not necessarily share a specific attribute by controlling different in-vehicle systems and components (e.g., lighting, climate, ventilation, radio, sound system, etc.) at the same time, with the press or a single button or selection of a single icon, for example. As a specific example, the user may utilize program 104 running on vehicle computer 102 or on smartphone 200 to adjust multiple settings related to ambient lighting, cabin temperature, user of the vehicle 100, settings related to lowering the cabin temperature, cabin ventilation, seat massage, seat ventilation, or playing a custom audio soundtrack on the sound system of the vehicle 100. Specifically, the vehicle interface (e.g., VIWI) can facilitate the ability to issue one command via a single button push (e.g., “Relax mode”) based on the user's request to simultaneously control multiple in-vehicle systems and components (e.g., seat massage, temperature, air ventilation direction, currently playing soundtrack, etc.). These multiple control requests are terminated in different ECUs in the vehicle (e.g., seat controller for massage, audio system for soundtrack, etc.)

Step 318 of presenting to the user the information about the selected vehicle function 500 can include, for example, additional information about the available radio favorites, the sound profiles, the climate control modes, and the wellness modes. For example, each of the displayed sound profiles can include adjustable, by the user of the vehicle 100, vehicle sound settings, such as treble, bass, fader, or surround, for example. These adjustable vehicle sound settings can be controlled and adjusted with one button press (e.g., icon “Music”) by the user on the dashboard or on the touchscreen of the vehicle 100.

The displayed radio favorites can include name and/or frequency band of a radio channel, or Uniform Resource Locator (URL) for web-based radio streaming services, for example. Once selected by the user, the displayed radio favorites can additionally include adjustable, by the user of the vehicle 100, settings related to vehicle sound settings, such as treble, bass, fader, or surround, for example, which can be applied to a selected radio channel. These adjustable radio favorites settings can be controlled and adjusted with one button press by the user on the dashboard or on the touchscreen of the vehicle 100.

The displayed climate control modes can include a Cool Down mode and a WarmUp mode, for example. Once selected by the user, the displayed Cool Down mode can additionally include adjustable, by the user of the vehicle 100, settings related to lowering the cabin temperature, cabin ventilation, turning on the seat ventilation, turning on the ambient light to blue, and playing a custom audio soundtrack on the sound system of the vehicle 100. Similarly, once selected by the user, the displayed WarmUp mode can additionally include settings related to increasing the cabin temperature, turning on the seat heating, turning on the ambient light to red, and playing a custom audio soundtrack on the sound system of the vehicle 100.

These adjustable climate control settings can be controlled and adjusted with one button press by the user on the dashboard or on the touchscreen of the vehicle 100.

Likewise, the displayed wellness modes can include a Relax mode and an Energize mode, for example. Once selected by the user, the displayed Relax mode can additionally include adjustable, by the user of the vehicle 100, settings related to turning on the ambient lighting to a color selected by the user, activating seat massage, turning on seat ventilation, or playing a custom audio soundtrack on the sound system of the vehicle 100.

These adjustable wellness settings can be controlled and adjusted with one button press by the user on the dashboard or on the touchscreen of the vehicle 100.

Regardless of the type or category of the selected vehicle function 500, the displayed information about the selected vehicle function 500 is contextually relevant in-vehicle information and contextually local vehicle function information, for the audience in the vehicle (e.g., driver, passengers).

Turning back to FIG. 3, in order to present the information about the selected vehicle function 500 to the user of the vehicle 100 (e.g., driver, passengers) in step 318, program 104 accesses the network of the vehicle 100 and obtains in-vehicle data related to the selected by the user vehicle function.

At step 320, program 104 can receive from the user (e.g., driver or passenger) of the vehicle 100 user input adjusting, by the user of the vehicle 100, the settings of the selected vehicle function 500. As described above, the user input can be in the form of the user selecting an icon or pressing a button on the touchscreen of vehicle computer 102. Alternatively, the user input can be in the form of a voice command by the user over an audio system of the vehicle 100. According to this embodiment, the user selection is accomplished using the input device (e.g., touch screen, stylus, mouse pad, keyboard, etc.) of vehicle 100, however, it should be understood that the selection could be accomplished using the input device (e.g., touch screen) of mobile device 200.

For example, in step 320, the user of the vehicle 100 can adjust the vehicle sound settings, such as treble, bass, fader, or surround, for example.

In addition, in step 320, the user of the vehicle 100 can select a radio channel from the displayed radio favorites and adjust vehicle sound settings, such as treble, bass, fader, or surround, for example, which can be applied to the selected radio channel.

In step 320, after selecting a Cool Down mode, a WarmUp mode, or a Relax mode, for example, the user of the vehicle 100 can also adjust settings related to the cabin temperature, the seat ventilation, the ambient lighting, and custom audio soundtracks played on the sound system of the vehicle 100.

Because settings related to the vehicle functions 500 can be pre-defined or pre-programmed and saved in the memory of vehicle computer 102 or mobile device 200, multiple adjustable vehicle function settings can be controlled and adjusted with one button press by the user on the dashboard or on the touchscreen of the vehicle 100.

In certain embodiments, once selected by the user, the settings related to the user-controlled vehicle functions 500, e.g., Cool Down mode, WarmUp mode, Relax mode, etc., can be configured to remain in force for a predetermined period of time (e.g., 4 minutes, for example).

It should be understood that method 300 is not limited to any particular step or sequence of steps.

In certain embodiments, the adjusted settings related to the user-controlled vehicle functions 500, e.g., Cool Down mode, WarmUp mode, Relax mode, etc., in program 104 can be synchronized with the vehicle states. For example, using the “Air Distribution” icon in program 104 (shown in FIG. 4), the user of the vehicle 100 can control and customize air distribution states in different areas of the vehicle 100 within the ecosystem of program 104 within CarPlay, without leaving CarPlay. This alleviates the need for the user to exit CarPlay and go into the native settings of the vehicle 100 in order to manually adjust the desired vehicle functions. The synchronization between the adjusted settings related to the user-controlled vehicle functions 500 and the vehicle states can be accomplished, for example, via a WebSocket communications protocol that enables a two-way interactive communication session between the user's browser (e.g., the user interface of program 104) and a server to observe, process, and store any and all changes by the user to the initial vehicle data. In particular, when the user of the vehicle 100 sends commands via the program 104 to the vehicle 100, the WebSocket broadcasts updates about any changes or adjustments in the settings of the user-controlled vehicle functions 500 that have occurred in the vehicle 100. As a result, after the user of the vehicle 100 successfully sends commands via the program 104 to make changes to settings related to the user-controlled vehicle functions 500, a WebSocket message indicates that the change to settings related to the user-controlled vehicle functions 500 has been successful. If no WebSocket message confirming the change to settings related to the user-controlled vehicle functions 500 is received, the system assumes that user's request to control settings related to the user-controlled vehicle functions 500 of the vehicle 100 did not succeed.

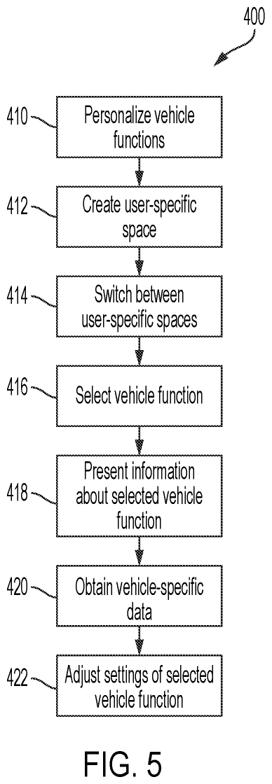

FIG. 5 is a flowchart depicting a method 400 for presenting information about a vehicle function 500 to a user of the vehicle 100. Method 400 is similar to method 300 depicted in FIG. 3, but expands on method 300 by performing additional steps. Although some of the steps of the method 300 of FIG. 3, such as connecting mobile device 200 to vehicle 100 (step 310), launching program 104 on vehicle computer 102 or mobile device 200 (step 312) are omitted in FIG. 5 for the sake of clarity and brevity, these steps are still performed, at an initial point, of the method 400.

Turning back to FIG. 5, at step 410 of method 400, program 104 can include the step of personalizing the selected vehicle function 500 based on the specific user's preferences. For example, the user can personalize the infotainment user interface of the vehicle 100, select the vehicle features and vehicle functions the user would like to see in the infotainment system, select information cards the user would like to see, and personalize infotainment behaviors.

The information cards can display on the touchscreen of the vehicle 100 vehicle functions 500 that the user needs most often or information cards the user would like to see occasionally, for example. For example, the information cards can include cards with vehicle-specific data (e.g., radio, sound profiles, ambient lighting, climate control, etc.).

In addition to the vehicle-specific data, the information cards can include cards with ecosystem data (e.g., current weather information, weather forecast, air quality index (AQI)), HomeKit cards, HomeKit scenes (“leaving home”, “arriving home”, “open” or “close” state for front door or garage door, etc.), Health Cards, point of interest (POI) cards, navigation display for navigating to a selected POI, etc. For example, with program 104, the user can view (and change) the status of important home accessories (alarm system, front door, garage door, lights, door locks, door sensors, thermostats, etc.). Using Home Kit scenes in program 104, the user can create custom scenes that allow the user to control multiple home app compatible accessories at once. For example, the user can create a “Coming Home” scene that will open the garage door, turn on lights, and set the thermostat to the user's preferred ideal temperature with one press of a button on program 104 directly from CarPlay.

In another example, program 104 can presents to the user directions for navigating the vehicle 100 to a selected point of interest (POI) within a pre-determined range from the current location of the vehicle 100. The navigating the vehicle 100 to the selected point of interest can be performed by presenting directions to the user for driving the vehicle 100 to the selected point of interest. Alternatively, the navigating the vehicle 100 to the selected point of interest can be performed by self-driving the vehicle to the selected point of interest.

In yet another example, Health Cards powered by Apple Health and integrated with program 104 can allow the vehicle users to track their fitness goals (Move, Stand, and Exercise) within the ecosystem of program 104 in CarPlay. For example, without leaving CarPlay, the users can monitor their daily activity statistics, calorie intake, and movement goals regardless of whether they might be driving to work, home or on the way to their next hike, boxing session, or recreational sports.

The available vehicle features 500 can be personalized to the specific user's preferences and can be adjusted according to predefined options. Alternatively, the user can adjust the predefined options to further suit the user's preferences.

The step of personalizing the selected vehicle function 500 based on the user's preferences can be executed by program 104 running on the vehicle computer 100 or on the smartphone 200, in real time between the smartphone 200 and the infotainment system of the vehicle 100.

In certain embodiments, program 104 can include step 412 of creating at least one space associated with a specific user of the vehicle. For example, the at least one space can include a plurality of personalized features associated with the specific user of the vehicle.

In certain embodiments, program 104 can include step 414 of switching between a plurality of spaces associated with multiple users of the vehicle 100.

In certain embodiments, step 318 of presenting to the user the information about the selected vehicle function 500 can include, for example, step 420 of accessing the vehicle network and obtaining vehicle data related to the selected vehicle function of the vehicle 100.

It should be understood that method 400 is not limited to any particular step or sequence of steps.

It should be understood that methods 300 and 40 are not limited to the particular examples of vehicle functions described herein. For example, methods 300 and 400 can be applied in a similar manner to present information to the user of vehicle 100 and enable control of a vehicle-related function or anything related to the in-vehicle user's experience, such as a current street the vehicle 100 is driving on, the current city or area the vehicle 100 is driving through, currently playing music, news, or podcasts, etc. The information can be conveniently presented to the user via the touchscreen of the vehicle 100 or via text-to-speech technology, using Apple CarPlay, Android Auto, Microsoft SYNC, or over the vehicle audio system, for example. In other words, the steps of methods 300 and 400 can be used to enhance the in-vehicle user's experience with any of the vehicle systems or software apps that are installed and running on vehicle's computer 102 or on a mobile device 200 connected to vehicle 100.

Also, although it has been described that program 104 on vehicle computer 102 performs the steps described herein, it should be understood that program 104 on mobile device 200 may perform these steps in lieu of vehicle computer 102.

In the context of the present description, the functions of program 104 may be carried out by a processor. The processor can be understood to mean a machine or an electronic circuit, for example. In particular, a processor can be a central processing unit (CPU), a microprocessor or microcontroller, for example an application-specific integrated circuit or digital signal processor, possibly in combination with a data storage unit for storing program commands, etc. Additionally, a processor can be understood to be a virtual processor, a virtual machine or soft CPU. The program 104 may be stored in the memory of the machine.

It will be understood that the operational steps are performed by the computers or processors described herein upon loading and executing software code or instructions which are tangibly stored on a tangible, non-transitory computer readable storage medium, such as on a magnetic medium, e.g., a computer hard drive, an optical medium, e.g., an optical disc, solid-state memory, e.g., flash memory, or other storage media known in the art. Thus, any of the functionality performed by the computers or processors described herein described herein is implemented in software code or instructions which are tangibly stored on a tangible, non-transitory computer readable storage medium. Upon loading and executing such software code or instructions by the computers or processors, the computers or processors may perform any of the functionality of the computers or processors described herein, including any steps of the methods described herein.

The term “software code” or “code” used herein refers to any instructions or set of instructions that influence the operation of computers or processors. They may exist in a computer-executable form, such as machine code, which is the set of instructions and data directly executed by a computer's central processing unit or by a controller, a human-understandable form, such as source code, which may be compiled in order to be executed by a computer's central processing unit or by a controller, or an intermediate form, such as object code, which is produced by a compiler. As used herein, the term “software code” or “code” also includes any human-understandable computer instructions or set of instructions, e.g., a script, that may be executed on the fly with the aid of an interpreter executed by a computer's central processing unit or by a controller.

It will also be understood that the terms and expressions used herein have the ordinary meaning as is accorded to such terms and expressions with respect to their corresponding respective areas of inquiry and study except where specific meanings have otherwise been set forth herein. The terms “comprises,” “comprising,” “includes,” “including,” or any other variation thereof, are intended to cover a non-exclusive inclusion, such that a process, method, article, or apparatus that has, comprises or includes a list of elements or steps does not include only those elements or steps but may include other elements or steps not expressly listed or inherent to such process, method, article, or apparatus. An element preceded by “a” or “an” does not, without further constraints, preclude the existence of additional identical elements in the process, method, article, or apparatus that comprises the element.

While the foregoing has described what are considered to be the best mode and/or other examples, it is understood that various modifications may be made therein and that the subject matter disclosed herein may be implemented in various forms and examples, and that they may be applied in numerous applications, only some of which have been described herein. It is intended by the following claims to claim any and all modifications and variations that fall within the true scope of the present concepts.

What is claimed is:

1. A computer-implemented method for presenting information about a vehicle function to a user of a vehicle and enabling control of the vehicle function, said method comprising the steps of:
(a) securely connecting a software application to a vehicle network;
(b) selecting a vehicle function from a plurality of vehicle functions;
(d) presenting to the user the information about the selected vehicle function; and
(e) controlling the selected vehicle function based on preferences of the user.

2. The computer-implemented method of claim 1, wherein the plurality of vehicle functions comprise a plurality of radio favorites, a plurality of sound profiles, a plurality of climate control modes, and a plurality of wellness modes.

3. The computer-implemented method of claim 2, wherein the plurality of sound profiles comprise Music, Podcast, Loud, Party, Baby mode, Spatial sound, and Quiet.

4. The computer-implemented method of claim 2, wherein each of the plurality of sound profiles is configured to update vehicle sound settings including treble, bass, fader, or surround, with one button press on a dashboard or a touchscreen of the vehicle.

5. The computer-implemented method of claim 2, wherein the plurality of climate control modes comprise a Cool Down mode and a WarmUp mode.

6. The computer-implemented method of claim 5, wherein the Cool Down mode comprises lowering a cabin temperature, turning on seat ventilation, turning on ambient light to blue, and playing a custom audio soundtrack on a sound system of the vehicle.

7. The computer-implemented method of claim 5, wherein the WarmUp mode comprises increasing a cabin temperature, turning on seat heating, turning on ambient light to red, and playing a custom audio soundtrack on a sound system of the vehicle.

8. The computer-implemented method of claim 7, wherein the plurality of wellness modes comprise a Relax mode and an Energize mode.

9. The computer-implemented method of claim 8, wherein the Relax mode comprises at least one of turning on ambient lighting to a color selected by the user, activating seat massage, turning on seat ventilation, or playing a custom audio soundtrack on a sound system of the vehicle.

10. The computer-implemented method of claim 8, wherein the Cool Down mode, the WarmUp mode, the Relax mode, and the Energize mode are configured to change, with a single button press, multiple vehicle functions including the cabin temperature, cabin ventilation, the seat ventilation, the ambient lighting, or the played custom audio soundtrack.

11. The computer-implemented method of claim 8, wherein, once selected by the user, the Cool Down mode, the WarmUp mode, the Relax mode, and the Energize mode are configured to remain in force for a predetermined period of time.

12. The computer-implemented method of claim 1, further comprising a step (f) of synchronizing the software application with a vehicle state based on the selected vehicle function.

13. The computer-implemented method of claim 1, further comprising a step (g) of personalizing the selected vehicle function based on user's preferences.

14. The computer-implemented method of claim 13, wherein the step (g) of personalizing the selected vehicle function based on the user's preferences is executed on a smartphone or on a computer of the vehicle.

15. The computer-implemented method of claim 13, further comprising a step (h) of creating at least one space associated with a specific user of the vehicle, wherein the at least one space comprises a plurality of personalized features associated with the specific user of the vehicle.

16. The computer-implemented method of claim 15, further comprising a step (i) of switching between a plurality of spaces associated with multiple users of the vehicle.

17. The computer-implemented method of claim 1, further comprising the step (j) of presenting to the user the information about the selected vehicle function comprises accessing the vehicle network and obtaining vehicle data related to the selected vehicle function.

18. A computer program product for presenting information about a vehicle function to a user of a vehicle and enabling control of the vehicle function, the computer program product being stored in a non-transitory computer-readable recording medium, wherein the computer program product is configured for:
(a) securely connecting to a vehicle network;
(b) selecting a vehicle function from a plurality of vehicle functions;
(c) presenting to the user the information about the selected vehicle function; and
(d) controlling the selected vehicle function based on preferences of the user.

19. A vehicle comprising the computer program product of claim 18.

20. A computer-implemented method for presenting information about a vehicle function to a user of a vehicle and enabling control of the vehicle function, said method comprising the steps of:
(a) securely connecting a software application to a vehicle network;
(b) selecting a vehicle function from a plurality of vehicle functions;
(d) presenting to the user the information about the selected vehicle function;
(e) obtaining vehicle data related to the selected vehicle function;
(f) adjusting the selected vehicle function based on preferences of the user; and
(f) synchronizing the software application with a vehicle state based on the selected vehicle function,
wherein the software application is configured to change, with a single button press, multiple vehicle functions related to different vehicle components.
